(19) United States
(12) Patent Application Publication
(10) Pub. No.: US 2003/0046800 A1
(43) Pub. Date: Mar. 13, 2003

(54) Hammer piston handling apparatus

(75) Inventors: Donald E. Mosing, Lafayette, LA (US); David L. Sipos, Youngsville, LA (US)

Correspondence Address: John D. Jeter, 1403 Teche Drive, St. Martinville, LA, 70582, US

(73) Assignee: FRANK'S CASING CREW AND RENTAL TOOLS, INC., Lafayette, LA (US)

(21) Appl. No.: 09/924,300

(22) Filed: Aug. 8, 2001

(51) Int. Cl. B23P 19/04

(52) U.S. Cl. 29/252

(57) ABSTRACT

A base is supported on adjustable jacks for aligning with a pile driver hammer body for removal or installation of the hammer piston. A terminal tube on the base clamps to the hammer and a powered ram moves the piston.

This invention pertains to free piston engines used as pile driving hammers. More particularly, it pertains to apparatus for removal and installation of pile driver pistons.

### BACKGROUND

Free piston engines, usually diesel, used for pile driving are usually shipped ready to run when delivered to the use location. For driving pilings, the hammer has to be hoisted up to clear a section length of pipe to be added to the piling. Then, from that position, the piling is driven down until another section of pipe needs to be added. The hoisting gear directly over the hammer when in use has to have the capacity to handle the whole assembly.

If the hoisting rig used to lift the hammer from the delivery conveyance cannot lift the total hammer, the piston can be removed and lifted separately. The piston may represent over one third of the assembly weight, often exceeding ten tons. Once on the rig floor, the hammer can be reassembled for use.

The rings on a ten ton piston are more subject to damage than on small engines. Relative to the piston, pile driver rings are light and delicate. The lands between the ring grooves can be damaged by the piston weight bearing upon other structure, in many circumstances.

Pistons ready for assembly into engines have to be protected to avoid piston detail damage. A piston handling carrier is needed. To manage a ten ton piston and slide it out of and into the cylinder of an engine, the carrier needs some features related to positioning, alignment, and application of manipulating force.

There is rarely enough room on petroleum related platforms for careless use of linear dimension to pull a long piston out of a still longer hammer with a long manipulating apparatus. The piston puller usually needs to be short.

Hammer design sometimes complicates field dismantling. Hammers normally have a catch ring on the piston and an annular catch ring receiving groove around the cylinder bore, near the top end of the hammer body. That arrangement prevents the piston being blown out of the hammer body in case a fuel charge is excessive due to fueling errors. That catch ring makes it about impossible to remove the piston through the top end of the cylinder bore. Such hammers normally require the piston be removed through the lower end of the hammer. That operation, in the field, is undesirable.

For hammers destined for piston and body separation for lifting from conveyance to platform, at the use site, the hammer bore is usually modified to make removal of the piston from the top end of the hammer more acceptable.

The top of the hammer cylinder is bored out above the catch ring receiving groove to allow the rings to pass through the top of the cylinder bore. Below the catch ring receiving groove the bore is already tapered to the piston fitting bore size, and that taper compresses the rings into their respective grooves during the downward excursion of the piston during installation. The catch ring receiving groove is effectively replaced by placing a sleeve in the bored out upper end such that the sleeve lower end replaces the former abutment to stop an overshooting piston. The sleeve is anchored by a flange that matches the flange normally in place atop the hammer body. In operation, the piston normally rises well above the flange on the up-stroke. To stabilize the piston, an extension with a lower flange is bolted to the body upper flange. The sleeve flange is captured between the hammer body upper flange and the extension lower flange. In operation, after the modification, the piston rides in a close fitting bore, excepting only the increased diameter of the catch ring receiving groove. In effect, the original bore is unchanged but a removable sleeve allows upper end removal of the piston. That practice already exists.

### SUMMARY OF INVENTION

The piston carrier has an elongated base with leveling and positioning legs. The legs are extendable from the sides of the base to achieve stable width, and the legs are individually extendable for leveling and height positioning of the base.

At the end of the base to be clamped to the hammer, when hammer and carrier are aligned, a tube corresponding to the cylinder bore of the hammer receives the emerging piston. The terminal tube is part of the carrier.

Once aligned, the piston still must be moved by substantial force. The needed force, for movement to or from the carrier, is provided by a forcing means, preferably, a hydraulic ram. The preferred ram is a short stroke unit to save space, and moves in a selected and reversible direction, in repeated short excursions, to walk the piston to the intended final position. The ram is on a ram carrier that moves on the frame, in ratcheting cycles, along the axial direction of the tube. The force ram arrangement is provided with a threaded coupler, to be installed on the piston, to couple the piston to the ram.

If the carrier is to be used only with bored out and sleeve fitted hammers, the terminal tube on the carrier can have a bore of the same diameter as the bored-out hammer cylinder bore. When the piston is later installed in the bored out body, the rings move down to the taper below the former catch ring receiving groove and are compressed into their respective grooves during the travel to the close-fitting cylinder bore.

If the carrier is to be used to install pistons into hammers not bored out above the catch ring receiving groove the terminal tube on the carrier has the same diameter as the close fitting portion of the cylinder bore of the hammer.

To pull a piston past the bored-out end of the hammer and into a close fitting bore on the carrier terminal tube, a sleeve with a tapered bore is inserted into the enlarged bore to re-compress the rings as the rings progress toward the close fitting bore of the carrier terminal tube. The piston then rests in the carrier with the rings compressed into their respective piston grooves.

These and other objects, advantages, and features of this invention will be apparent to those skilled in the art from a consideration of this specification, including the attached claims and appended drawings.

### BRIEF DESCRIPTION OF DRAWINGS

FIG. 1 is a top view of the apparatus, associated with a hammer from which the piston is being removed.

FIG. 2 is an end view of the apparatus showing the support and positioning systems.

FIG. 3 is a side view of the apparatus.

FIG. 4 is a fragmented side view of the ratcheting system enabling lengthy travel in short strokes.

FIG. 5 is fragmented sectional side view taken along line 5-5.

FIG. 6 is a side view of a section through the wall of a typical hammer cylinder.

FIG. 7 is a view similar to FIG. 6, with the bore modified to enable top end removal of the hammer piston.

FIG. 8 is a view similar to FIG. 7, with a catch ring substitute sleeve in the hammer cylinder bore.

FIG. 9 is a view similar to that of FIG. 8, with a ring compressor sleeve in place.

FIG. 10 is a side view of an alternate form of force means for moving a piston out of and into a hammer.

FIG. 11 is a side view of an alternate form of force means for moving a piston out of and into a hammer.

### DETAILED DESCRIPTION OF DRAWINGS

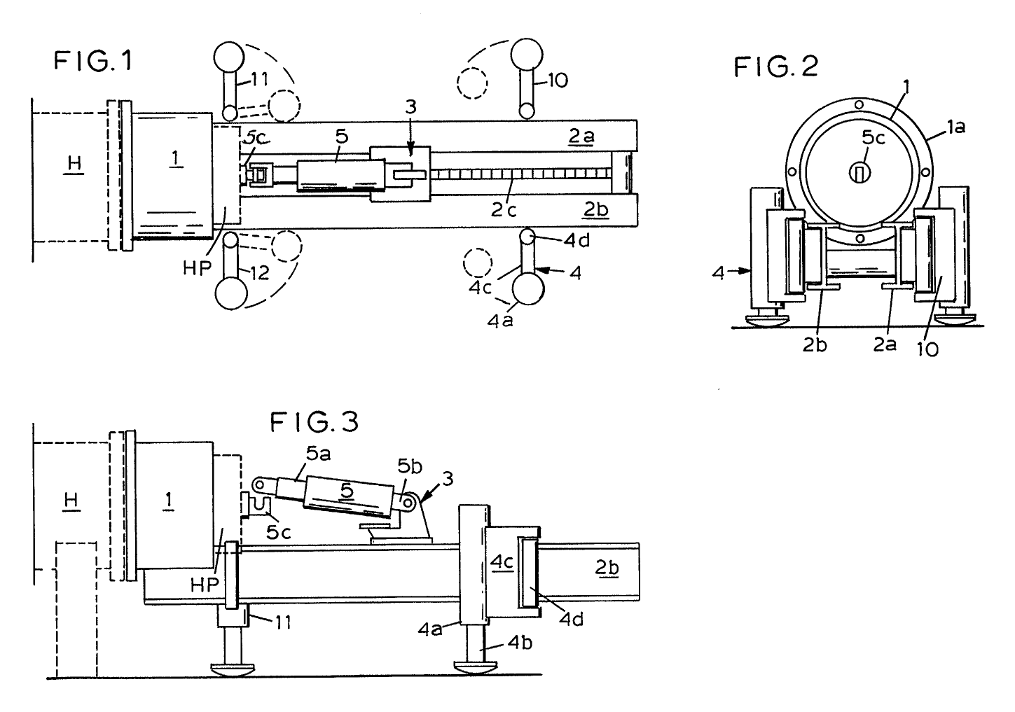

FIG. 1 shows hammer H aligned with the apparatus in the relationship to accept the transfer of the piston HP to the apparatus.

Support and positioning jacks 4, 10, 11, and 12 are distributed around the base 2. Only jack 4 has parts captioned. Flanged tube 1 is the means to anchor the hammer to the apparatus. Tube 1 has a flange 1a to be clamped to the upper flange of the hammer serviced. Longitudinal beams 2a and 2b function as a frame, carry the force cylinder 5 on fixture 3 and transfers loads to the jacks.

The piston HP is accessed by an adapter 5c which is engaged by the pin of clevis 5c which is part of the force cylinder 5. Hammer pistons normally have a threaded hole in the center of the top for such adapters.

Force cylinder 5 moves in short strokes to move the piston HP a short distance and, on the reverse stroke, the carrier 3 slides on the flanges of beams 2a and 2b. A few strokes will transfer a piston. The ratcheting action of carrier 3 is reversible to achieve a reverse transfer.

FIG. 2 shows the preferred support and positioning jack system. Carrier 3 and related parts are not shown. Hard point 4d has a vertical axis to carry web 4c and is welded to the longitudinal frame beam 2b. Cylinder body 4a is attached to web 4c which has hinge hubs that are carried by hard point 4d. The jacks fold alongside the frame for transport as shown by dashed lines. End view 2 shows the jacks 4 and 10, partly folded.

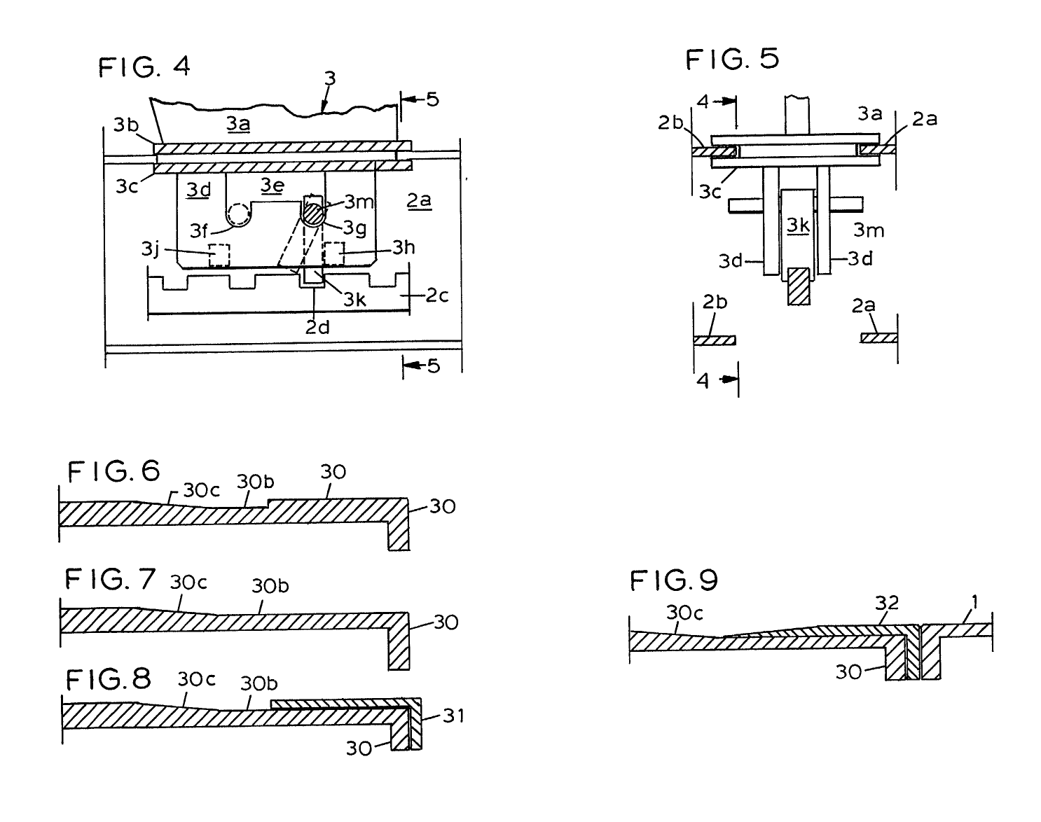

FIG. 3 shows cylinder 5 tilted to disconnect from the adapter 5c that screws into the top of the piston. The details of the ratcheting contrivance related to carrier 3 are deferred to FIGS. 4 and 5. The jack 12 is removed to show only the frame hard point 12d. All Jack details are identical to those on jack 4.

FIGS. 4 and 5 show details related to the shuttle carrier 3 of FIG. 1. Carrier 3 moves longitudinally between the base beams and rides the upper flanges of those beams. Longitudinal thrust rod 2c is secured to the frame by means not shown and has notches 2d separated by buttresses. Flapper 3k can swing leftward as shown by dotted lines and allows the carrier to move rightward, but the flapper cannot swing rightward because it hits barrier 3h. Carrier 3, then, can only move rightward. If the pivot cross bar 3m of the flapper is lifted out of slot 3g and moved to slot 3f, the carrier will move leftward only because barrier 3j requires reverse swing directions for the flapper. Cutout 3e provides clearance for manipulation of the flapper.

FIGS. 6 and 7 show sections through one wall of the upper end of the cylinder of the usual free-piston engine type pile driver. FIGS. 6 through 8 do not represent points of novelty of the present invention. FIG. 9 represents novel features that make it possible to use a carrier with a bore closely fitting the hammer piston to remove and replace pistons from any bore condition shown in FIGS. 6 and 7. There is no reason to transfer a piston to or from a bore fitted with the sleeve of FIG. 8.

FIG. 6 shows a common hammer cylinder with a catch ring receiving groove. The catch ring receiving groove has a bore taper 30c to a larger diameter groove 30b ended by abutment 30d.The groove 30b is of such diameter that a ring can come only part way out of its related piston groove to engage abutment 30d. That stops the upward travel of a piston. Assuming no hammer damage, the piston slides back down the bore with cone 30c compressing the ring back into the ring groove. A piston could be installed from the top (right) end of the cylinder. Each ring, in it's turn, would emerge some from the related groove as it passed abutment 30d but it would be pushed back into the groove by conic surface 30c. The piston, however, cannot be removed from the top.

The hammer cylinder is modified by boring out the cylinder above abutment 30d to allow the rings to move upward and out of the cylinder.

Safety interests require that the catch ring be effective in the field. The sleeve 31 is installed such that its lower end duplicates the former abutment 30d. The upper flange of the sleeve is captured between flanges in the fully assembled hammer as shown in FIG. 9.

In FIG. 9, sleeve 32 is provided for a bored out cylinder, after sleeve 31 is removed. Sleeve 32, ideally, reaches very close to the big end of the surface 30c so that it picks up the outer periphery of an upwardly moving ring before the ring expands to bear against the enlarged wall of the bored-out cylinder. That reduces the need for a sharp end on sleeve 32 in case outer bevels are not on the rings to be compressed.

In case a sleeve 32 is not available, the piston can still be pulled from the hammer until the rings engage the face of terminal ring 1 on the carrier. The carrier can the be moved back from the hammer, exposing the rings. A ring compressor band can then be used to compress the rings. The carriers cylinder 5 can then move the piston back into the close fitting bore of the terminal tube.

By tapering both ends of the bore of the terminal tube, rings can be compressed when entering the tube from either end. Repaired pistons, returned to the carrier, enter the tube from the right end as shown in the drawings.

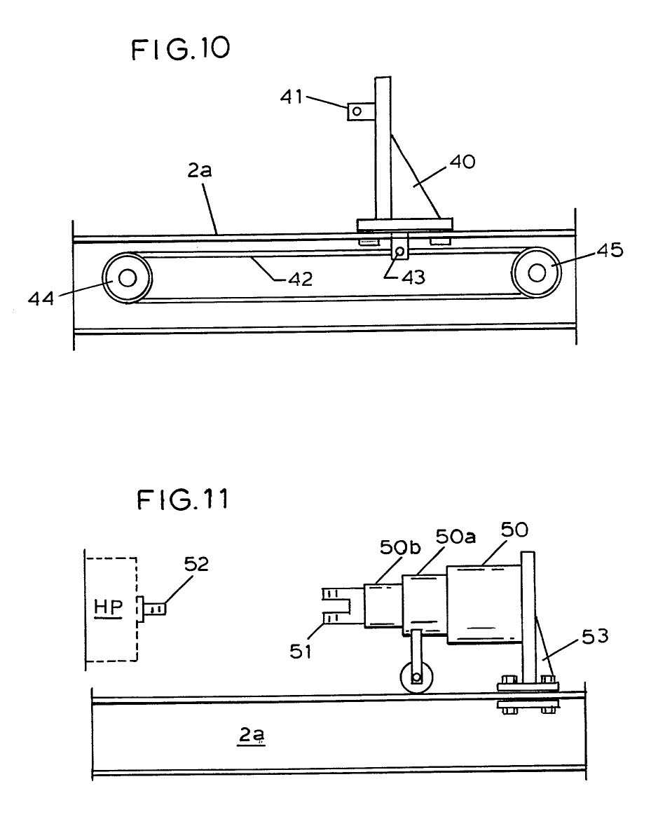

FIG. 10 shows an alternate machine to manipulate hammer pistons. On base 2a, carriage 40 slides longitudinally on base 2a, attached at coupler means 43 to chain 42. Chain 42 is driven by powered sprocket 45, and distributed by idler sprocket 44. Adapter 41 connects the carriage to the piston to be moved.

FIG. 11 shows an alternate force means for moving piston HP. Multi-stage hydraulic cylinder 50 is mounted on stationary bracket 53. The cylinder 50 has two overlapping telescoping members, 50a and 50b. Cylinder 50 has enough stroke to move the piston as needed in single excursions. Adapter 51 is arranged for quick coupling to piston adapter 52.

From the foregoing, it will be seen that this invention is one well adapted to attain all of the ends and objects hereinabove set forth, together with other advantages which are obvious and which are inherent to the apparatus.

It will be understood that certain features and sub-combinations are of utility and may be employed without reference to other features and sub-combinations. This is contemplated by and is within the scope of the claims.

As many possible embodiments may be made of the apparatus of this invention without departing from the scope thereof, it is to be understood that all matter herein set forth or shown in the accompanying drawings is to be interpreted as illustrative and not in a limiting sense.

The invention having been described, we claim,

1. A piston manipulation apparatus for use with pile driving hammers, the apparatus comprising:
a) a elongated frame to receive a removed piston, and to support and direct piston forcing means, with adjustable standard means to support the frame above a preselected surface;
b) force means arranged to ride the longitudinal direction of said frame and exert piston moving force in said longitudinal direction, said force means having means to temporarily connect to said piston, and means to releasably connect to said frame.

2. The apparatus of claim 1 wherein said forcing means is a reciprocating force means, attached to said frame by directionally selectable ratcheting means such that reciprocal stroking of said force means causes said ratcheting means to proceed in one direction until reversed.

3. The apparatus of claim 1 wherein said force means is attached to the frame by a directionally selectable ratchet arrangement whereby said force means, in succeeding short strokes, progresses in one direction along said frame until switched to proceed in the opposite direction.

5. The apparatus of claim 1 wherein said force means is a hydraulic cylinder and said means to releasably connect to said frame is a ratchet means by which said cylinder can extend to move said piston in one direction and can retract to move said means to releasably connect to said frame in the same direction whereby several strokes of said cylinder can move said piston a distance, in one direction, equal to the several strokes of said cylinder.

6. The apparatus of claim 1 wherein said force means is a carriage moved by a chain powered through at least two separated sprockets distributed along said frame.

7. The apparatus of claim 1 wherein said adjustable standard means is a plurality of jacks distributed about said frame.

8. The apparatus of claim 5 wherein said plurality of jacks are each carried by folding structure attached to said base by which the overall apparatus can be narrowed for transport and widened for stability, said jacks remaining functional for apparatus support in various positions related to said folding.

9. A piston handling apparatus for removing and replacing the piston of a pile driving hammer, the apparatus comprising:
a) a frame arranged to receive and support said piston;
b) support and positioning apparatus arranged to support said frame, above an underlying surface, and to align a first end of said frame with the piston bore of said hammer;
c) means to secure said frame to said hammer;
d) forcing means situated to move along said frame and push said piston into said hammer and to pull it from said hammer.

10. The apparatus according to claim 9 wherein said frame includes a terminal tube to receive said piston.

11. The apparatus according to claim 10 wherein the bore of said tube is provided with a conical length on at least one end to receive said piston with expanded rings and compress said rings into the related piston ring grooves when said piston moves along said bore.

12. The apparatus according to claim 9 wherein said forcing means is a carriage arranged to move longitudinally along said frame, with means for temporary attachment to said piston.

13. The apparatus according to claim 9 wherein said force means is a carriage situated to move longitudinally on said base, urged to move is a selected direction by a chain moved by a powered sprocket.

14. The apparatus according to claim 9 wherein said force means is a fluid powered cylinder arranged to move said piston a full excursion in a single stroke.

15. The apparatus according to claim 1 wherein said force means is a carriage situated to move longitudinally on said base, urged to move is a selected direction by a chain moved by a powered sprocket.

16. The apparatus according to claim 1 wherein said force means is a fluid powered cylinder arranged to move said piston a full excursion in a single stroke.
